(19) United States
(12) Patent Application Publication
(10) Pub. No.: US 2026/0134251 A1
(43) Pub. Date: May 14, 2026

(54) Method and apparatus for obtaining multi-modality features

(71) Applicant: Alipay (Hangzhou) Information Technology Co., Ltd., Hangzhou (CN)

(72) Inventors: Xuzheng YU, Hangzhou (CN); Qingpei GUO, Hangzhou (CN)

(21) Appl. No.: 19/009,793

(22) Filed: Jan. 3, 2025

(30) Foreign Application Priority Data
Jan. 3, 2024 (CN) 202410010966.7

(51) Int. Cl. G06N 3/045

(52) U.S. Cl. CPC G06N 3/045

(57) ABSTRACT

Embodiments of this specification provide a method and an apparatus for obtaining multi-modality features. The method includes: obtaining first information of a first modality, and obtaining first related information of the first modality and second related information of a second modality from a predetermined multi-modality retrieval database based on the first information; and inputting the first information and the first related information into a first encoder corresponding to the first modality to obtain a first feature, inputting the second related information into a second encoder corresponding to the second modality to obtain a second feature, and inputting the first feature and the second feature into a cross-encoder to obtain a multi-modality feature.

### TECHNICAL FIELD

One or more embodiments of this specification relate to the field of deep learning, and in particular, to a method and an apparatus for obtaining multi-modality features.

### BACKGROUND

Increasingly more data are generated during operation of the modern society, including data of various modalities such as text, image, audio, video, etc. There is complex association and interaction between these multi-modality data, so it is desirable to combine these data efficiently, for example, for training of a multi-modality large model, to improve an analysis and processing capability of a multi-modality model for multi-modality data. Currently, training of an existing multi-modality large model relies on a multi-modality dataset that needs to be manually annotated in a specific task. However, construction costs of the manually annotated dataset are very high, and a size of the dataset is also limited. Consequently, a training effect and a generalization capability of the multi-modality large model are limited.

### SUMMARY

Embodiments of this specification are intended to provide a method and an apparatus for obtaining multi-modality features, so that rich multi-modality data can be used to extract multi-modality features through retrieval of information of different modalities. Further, the extracted multi-modality features can be used in training of a multi-modality large model, so that data used in model training can be significantly enriched, construction costs of training data are reduced, a training effect and a generalization capability of a model are improved, and deficiencies in the conventional technology are resolved.

According to a first aspect, a method for obtaining multi-modality features is provided, including:
obtaining first information of a first modality, and obtaining first related information of the first modality and second related information of a second modality from a predetermined multi-modality retrieval database based on the first information; and
inputting the first information and the first related information into a first encoder corresponding to the first modality to obtain a first feature, inputting the second related information into a second encoder corresponding to the second modality to obtain a second feature, and inputting the first feature and the second feature into a cross-encoder to obtain a multi-modality feature.

In a possible implementation, the first modality and the second modality each are one of a text modality, an image modality, or a video modality, and the second modality is different from the first modality.

In a possible implementation, the method further includes:
obtaining second information of the second modality, and obtaining third related information of the second modality and fourth related information of the first modality from the multi-modality retrieval database based on the second information;
the inputting the first information and the first related information into a first encoder corresponding to the first modality to obtain a first feature includes: inputting the first information, the first related information, and the fourth related information into the first encoder corresponding to the first modality to obtain the first feature; and
the inputting the second related information into a second encoder corresponding to the second modality to obtain a second feature includes: inputting the second information, the second related information, and the fourth related information into the second encoder corresponding to the second modality to obtain the second feature.

In a possible implementation, a plurality of key-value pairs are pre-stored in the multi-modality retrieval database, a key in the key-value pair is used to store a feature of pre-obtained information of the first modality, and a value in the key-value pair is used to store related information of a same modality as the information of the first modality and related information of a different modality from the information of the first modality.

In a possible implementation, the key in the key-value pair has a first identifier that is used to identify a modality corresponding to the information stored in the key, and the value in the key-value pair has a second identifier that is used to identify a modality corresponding to the information stored in the value.

In a possible implementation, the obtaining first related information of the first modality and second related information of a second modality from a predetermined multi-modality retrieval database based on the first information includes:
extracting a first extracted feature from the first information through a pre-trained feature extractor; and
obtaining, from the predetermined multi-modality retrieval database, the first related information and the second related information that are comprised in values corresponding to a plurality of keys in a k-nearest neighbor of the first extracted feature.

In a possible implementation, the key in the key-value pair is further used to store a feature of pre-obtained information of the second modality, and the value in the key-value pair is used to store related information of a same modality as the information of the second modality and related information of a different modality from the information of the second modality.

In a possible implementation, the cross-encoder is based on a Transformer model.

In a possible implementation, the first modality is a text modality, and the first encoder corresponding to the first modality is based on one of a bag-of-words model, a sequence model, or an attention mechanism model.

In a possible implementation, the first modality is an image modality or a video modality, and the first encoder corresponding to the first modality is based on one of a convolutional neural network or a Transformer model.

In a possible implementation, the first modality is a text modality, the second modality is an image modality or a video modality, the first related information is context information of the first information, the second related information is an image or a video related to text content in the first information, the third related information is an image or a video of a same type as the second information, and the fourth related information is text related to image content in the second information.

According to a second aspect, an apparatus for obtaining multi-modality features is provided, and the apparatus includes:
a related information acquisition unit, configured to obtain first information of a first modality and obtain first related information of the first modality and second related information of a second modality from a predetermined multi-modality retrieval database based on the first information; and
a feature extraction unit, configured to input the first information and the first related information into a first encoder corresponding to the first modality to obtain a first feature, input the second related information into a second encoder corresponding to the second modality to obtain a second feature, and input the first feature and the second feature into a cross-encoder to obtain a multi-modality feature.

According to a third aspect, a computer-readable storage medium is provided. The computer-readable storage medium stores a computer program. When the computer program is executed in a computer, the computer is enabled to perform the method according to the first aspect.

According to a fourth aspect, a computing device is provided, and includes a memory and a processor. The storage stores executable code. When the processor executes the executable code, the method according to the first aspect is implemented.

Based on one or more of the method, the apparatus, the computing device, or the storage medium in the above-mentioned aspects, data used in model training can be significantly enriched, construction costs of training data are reduced, a training effect and a generalization capability of a model are improved, and deficiencies in the conventional technology are resolved.

### BRIEF DESCRIPTION OF DRAWINGS

To describe the technical solutions in the embodiments of this specification more clearly, the following briefly describes the accompanying drawings needed for describing the embodiments. Clearly, the accompanying drawings in the following description show merely some embodiments of this specification, and a person of ordinary skill in the art can derive other drawings from these accompanying drawings without creative efforts.

FIG. 1 is a schematic diagram of a principle of a method for obtaining multi-modality features according to an embodiment of this specification;

FIG. 2 is a schematic diagram of a method for obtaining multi-modality features according to another embodiment of this specification;

FIG. 3 is a flowchart of a method for obtaining multi-modality features according to an embodiment of this specification;

FIG. 4 is a schematic diagram of a key-value pair in a multi-modality database according to an embodiment of this specification;

FIG. 5 is a schematic diagram of performing retrieval based on first information and second information according to an embodiment of this specification; and

FIG. 6 is a structural diagram of an apparatus for obtaining multi-modality features according to an embodiment of this specification.

### DESCRIPTION OF EMBODIMENTS

The solutions provided in this specification are described below with reference to the accompanying drawings.

As mentioned above, increasingly more data are generated in operation of the modern society, including data of a plurality of modalities such as text, image, video, etc. There is complex association and interaction between these multi-modality data, so it is desirable to combine these data efficiently, for example, for training of a multi-modality large model, to improve an analysis and processing capability of a multi-modality model for multi-modality data. Currently, training of a multi-modality large model mainly relies on a multi-modality dataset that needs to be manually annotated in a specific task. However, construction costs of the manually annotated dataset are very high, and a size of the dataset is also limited. Consequently, a training effect and a generalization capability of the multi-modality large model are limited. To resolve the above-mentioned technical problem, a method for obtaining multi-modality features is provided in embodiments of this specification.

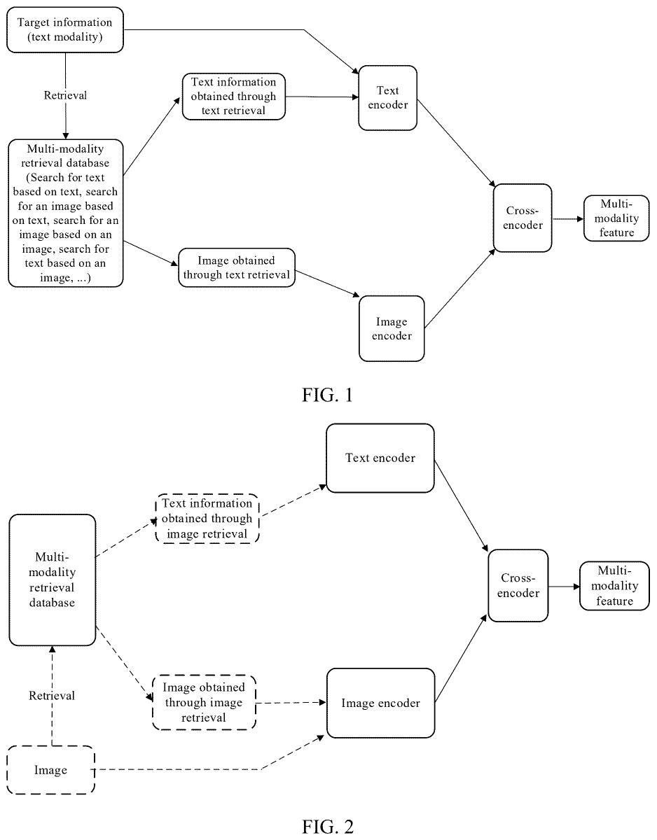

FIG. 1 is a schematic diagram of a principle of a method for obtaining multi-modality features according to an embodiment of this specification. As shown in FIG. 1, based on information of one modality, for example, based on to-be-retrieved information of a text modality, other text information related to the to-be-retrieved information and information (e.g., a related image) of another modality (e.g., an image modality) related to the to-be-retrieved information can be retrieved from a predetermined multi-modality retrieval database. Then, the to-be-retrieved information and the other text information related to the to-be-retrieved information are input into a text encoder to obtain a first feature, and an image related to the to-be-retrieved information is input into an image encoder to obtain a second feature. Afterwards, the first feature and the second feature are combined to obtain a multi-modality feature. In different embodiments, the to-be-retrieved information can be in different modalities. FIG. 2 is a schematic diagram of obtaining multi-modality features according to another embodiment of this specification. As shown in FIG. 2, for example, based on to-be-retrieved information of an image modality, which is referred to as a to-be-retrieved image, another image related to the to-be-retrieved image and text information or the like related to the to-be-retrieved image can be retrieved from a predetermined multi-modality retrieval database. Then, the to-be-retrieved image and the another image related to the to-be-retrieved image are input into an image encoder to obtain a second feature, and text information related to the to-be-retrieved image is input into a text encoder to obtain a first feature. Afterwards, the first feature and the second feature are combined to obtain a multi-modality feature. In another embodiment, the to-be-retrieved information can also be information of another modality. The multi-modality retrieval database is a database that supports intra-modality and inter-modality retrieval operations for modality data of a plurality of modalities including text, image, video, etc. For example, related text can be retrieved based on text, a related image can be retrieved based on an image, a related video can be retrieved based on text, related text can be retrieved based on an image, . . . , etc. In a specific embodiment, the multi-modality retrieval database can be, for example, a key-value pair database, and can extract, through a pre-trained encoder of each modality (e.g., a text encoder, an image encoder, or a video encoder), features of rich data of various modalities included in licensed network resources or public network resources, etc., and use the features as keys in key-value pairs in the database, and use data of a same modality or data of another modality that is related to data of each modality as values in key-value pairs in the database. For example, in an example, for text information, a feature of the text information can be extracted as a key, and context of the text information and an image or a video that is displayed at the same time as the text information in an extraction source are used as a value. In another example, for example, for image information, a feature of the image or the information can be extracted as a key, and context of the image information and an image or a video that is displayed at the same time as the image information in an extraction source are used as a value. Therefore, during retrieval, based on retrieved information, information of a same modality and information of another modality that are related to the retrieved information can be retrieved from the multi-modality retrieval database.

The method has the following advantages: It is convenient to extract, for example, rich data of a plurality of modalities included in licensed network resources or public network resources, and store the data in the predetermined multi-modality retrieval database, so that related information of a same modality and related information of another modality can be retrieved from the multi-modality retrieval database based on to-be-retrieved information. Then, encoders corresponding to the same modality and the another modality are used to extract features of the same modality and the another modality, and a multi-modality feature is obtained after the features of the same modality and the another modality are combined. Afterwards, the multi-modality feature can be used in training of various multi-modality large models. Therefore, in essence, a large amount of multi-modality data in network resources can be conveniently and automatically integrated into training of the multi-modality large model without manually annotating the data, which can significantly improve the richness of data used in training of the multi-modality large model, reduce costs, and improve a training effect and a generalization capability of the model.

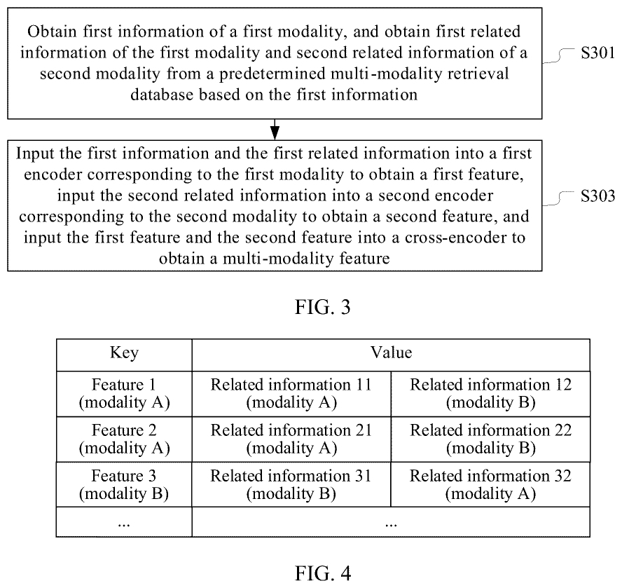

The following further describes a detailed process of the method. FIG. 3 is a flowchart of a method for obtaining multi-modality features according to an embodiment of this specification. As shown in FIG. 3, the method includes at least the following steps:
Step S301: Obtain first information of a first modality, and obtain first related information of the first modality and second related information of a second modality from a predetermined multi-modality retrieval database based on the first information.
Step S303: Input the first information and the first related information into a first encoder corresponding to the first modality to obtain a first feature, input the second related information into a second encoder corresponding to the second modality to obtain a second feature, and input the first feature and the second feature into a cross-encoder to obtain a multi-modality feature.

First, in step S301, the first information of the first modality is obtained, and the first related information of the first modality and the second related information of the second modality are obtained from the predetermined multi-modality retrieval database based on the first information.

In this step, related information (e.g., the first related information) of a same modality and related information (e.g., the second related information) of a different modality can be obtained from the predetermined multi-modality retrieval database based on the obtained first information. In different embodiments, the first modality can be different specific modalities, the first information can be different specific information of the different specific modalities, and the second modality can be a modality different from the first modality. This is not limited in this specification. For example, in an embodiment, the first modality and the second modality each can be one of a text modality, an image modality, or a video modality, and the second modality is different from the first modality. In an example, the first modality can be, for example, a text modality, and the second modality can be an image modality. In another example, the first modality can be, for example, an image modality, and the second modality can be a video modality. In still another example, the first modality can be, for example, a video modality, and the second modality can be a text modality.

The multi-modality retrieval database can be used to retrieve, based on information of different modalities, related information of a same modality as the information and related information of a different modality from the information. For example, in an example, image information and other text information that are related to to-be-retrieved information of the text modality can be retrieved by using the multi-modality retrieval database. In another example, other image information and text information that are related to to-be-retrieved information of the image modality (a to-be-retrieved image) can be retrieved by using the multi-modality retrieval database. In different embodiments, a specific modality of the to-be-retrieved information and a specific modality of related information of the to-be-retrieved information retrieved from the multi-modality retrieval database can differ. This is not limited in this specification.

In different embodiments, a specific method for constructing the multi-modality retrieval database can differ. In an embodiment, a plurality of key-value pairs can be pre-stored in the multi-modality retrieval database, a key in the key-value pair is used to store a feature of pre-obtained information of the first modality, and a value in the key-value pair is used to store related information of a same modality as the information of the first modality and related information of a different modality from the information of the first modality. In an embodiment, the key in the key-value pair is further used to store a feature of pre-obtained information of the second modality, and the value in the key-value pair is used to store related information of a same modality as the information of the second modality and related information of a different modality from the information of the second modality. FIG. 4 is a schematic diagram of a key-value pair in a multi-modality database according to an embodiment of this specification. In the example shown in FIG. 4, for example, a plurality of key-value pairs are stored in the multi-modality database, e.g., a “feature 1” key-value pair, a “feature 2” key-value pair, . . . , etc. A key in the “feature 1” key-value pair stores feature 1, and feature 1 can be, for example, a feature extracted based on information (e.g., message a) of modality A. A value in the “feature 1” key-value pair stores, for example, related information 11 of modality A of message a and related information 12 of modality B. A key in the “feature 2” key-value pair stores feature 2, and feature 2 can be, for example, a feature extracted based on information (e.g., message b) of modality B. A value in the “feature 2” key-value pair stores, for example, related information 21 of modality B of message b and related information 22 of modality A. In different specific examples, modality A and modality B can be different specific modalities. In one example, modality A can be a text modality, and modality B can be an image modality. In another example, modality A can be an image modality, and modality B can be a video modality. In different embodiments, a key in the key-value pair in the multi-modality retrieval database can further store features and related information of information of two or more modalities. In one example, a key in each key-value pair can store a feature of one of text information, image information, or video information, and a value in each key-value pair can store related information of a same modality as source information of a key feature and related information of one or more modalities different from the modality of the source information of the key feature. In different embodiments, the key or value in the key-value pair can further store an identifier of the key or value, to identify a modality of a feature or data corresponding to the key or value. In a specific embodiment, the key in the key-value pair has a first identifier that is used to identify a modality corresponding to the information stored in the key, and the value in the key-value pair has a second identifier that is used to identify a modality corresponding to the information stored in the value. In different embodiments, a specific method for obtaining key information and value information from the multi-modality retrieval database can differ, and is not limited in this specification. In an embodiment, for example, rich information of different modalities included in licensed network resources or public network resources can be extracted, and a key in the multi-modality retrieval database and a corresponding value thereof can be determined based on a relationship between the information.

In different embodiments, a specific method for obtaining the first related information and the second related information from the predetermined multi-modality retrieval database based on the first information can also differ. In the above-mentioned embodiment in which the multi-modality retrieval database is a key-value pair database, a first extracted feature can be extracted from the first information through a pre-trained feature extractor, and the first related information and the second related information that are included in values corresponding to a plurality of keys in a k-nearest neighbor of the first extracted feature are obtained from the predetermined multi-modality retrieval database.

In some scenarios, in addition to retrieval based on information of a single modality, retrieval can be performed based on information of associated different modalities. Therefore, in an embodiment, second information of the second modality can be further obtained, and third related information of the second modality and fourth related information of the first modality are obtained from the multi-modality retrieval database based on the second information; In different embodiments, specific modalities of the first information and the second information can differ. Further, the first related information and the second related information that are related to the first information and the third related information and the fourth related information that are related to the second information can also be different specific information. This is not limited in this specification. In an embodiment, the first modality can be, for example, a text modality, and the second modality can be an image modality or a video modality. Further, the first related information can be context information of the first information, the second related information can be an image or a video related to text content in the first information, the third related information is an image or a video of a same type as the second information, and the fourth related information is text related to image content in the second information.

Then, in step S303, the first information and the first related information can be input into a first encoder corresponding to the first modality to obtain a first feature, the second related information is input into a second encoder corresponding to the second modality to obtain a second feature, and the first feature and the second feature are input into a cross-encoder to obtain a multi-modality feature.

In this step, the first information and the first related information that are obtained in step S301 are input into the first encoder to obtain the first feature, and the second related information that is obtained in step S301 is input into the second encoder to obtain the second feature. The first feature and the second feature are input into the cross-encoder to obtain the multi-modality feature. In different embodiments, a specific type of the first encoder or the second encoder or a neural network model used for the first encoder or the second encoder can differ based on a specific type of the first modality or the second modality. In an embodiment, the first modality can be a text modality, and the first encoder corresponding to the first modality is based on one of a bag-of-words model, a sequence model, or an attention mechanism model. In an embodiment, the first modality can be an image modality or a video modality, and the first encoder corresponding to the first modality can be based on one of a convolutional neural network or a Transformer model. In different embodiments, a specific type of the cross-encoder or a neural network model used for the cross-encoder can also differ. In one embodiment, the cross-encoder can be based on a Transformer model.

In the above-mentioned embodiment in which retrieval is performed based on information of associated different modalities, the first information, the first related information, and the fourth related information can further be input into the first encoder corresponding to the first modality to obtain a first feature, and the second information, the second related information, and the fourth related information are input into the second encoder corresponding to the second modality to obtain a second feature. Then, the first feature and the second feature are input into the cross-encoder to obtain a multi-modality feature. In different embodiments, the first modality can be a different specific modality, and the second modality can be a modality different from the first modality. FIG. 5 is a schematic diagram of performing retrieval based on first information and second information according to an embodiment of this specification. As shown in FIG. 5, for example, based on to-be-retrieved information of a text modality, other text information related to the to-be-retrieved information and a related image of the to-be-retrieved information can be retrieved from the multi-modality retrieval database. Based on a to-be-retrieved image, another image related to the to-be-retrieved image and text information related to the to-be-retrieved image are retrieved from the multi-modality retrieval database. Then, the to-be-retrieved information, the other text information related to the to-be-retrieved information, and the text information related to the to-be-retrieved image are input into a text encoder to obtain a first feature, and the to-be-retrieved image, another image related to the to-be-retrieved image, and the related information of the to-be-retrieved information are input into an image encoder to obtain a second feature. Afterwards, the first feature and the second feature are combined to obtain a multi-modality feature.

In different embodiments, after the multi-modality feature is obtained, the multi-modality feature can be used in different model training tasks, which is not limited in this specification. In an embodiment, the multi-modality feature can be used in training of a multi-modality large model, and the multi-modality large model is a deep learning model that is trained by using a large scale amount of multi-modality data and that includes 10 billion or more parameters. In a specific embodiment, for example, the multi-modality feature can be used to train one of a classification model, a regression model, or a generation model for one-modality data to multi-modality data.

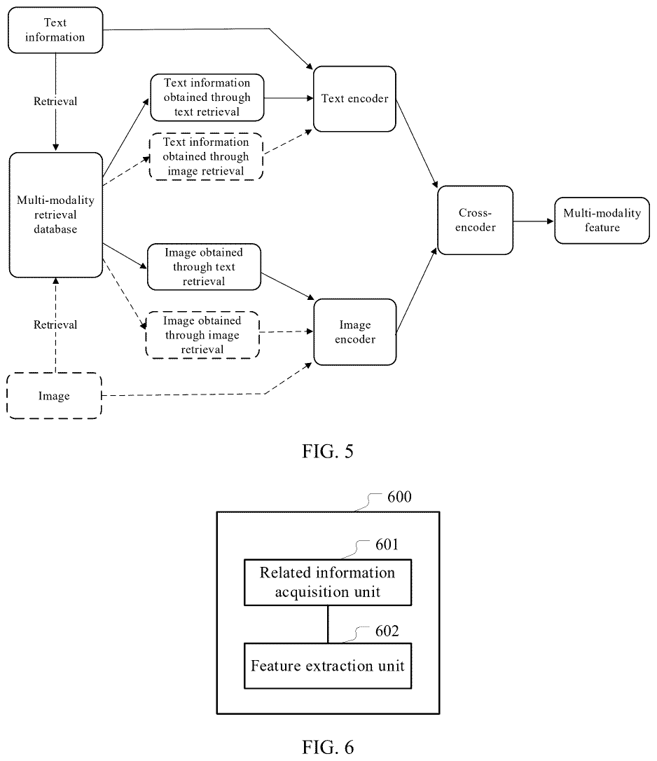

According to an embodiment of yet another aspect, an apparatus for obtaining multi-modality features is further provided. FIG. 6 is a structural diagram of an apparatus for obtaining multi-modality features according to an embodiment of this specification. As shown in FIG. 6, the apparatus 600 includes:
a related information acquisition unit 601, configured to obtain first information of a first modality and obtain first related information of the first modality and second related information of a second modality from a predetermined multi-modality retrieval database based on the first information; and
a feature extraction unit 602, configured to: input the first information and the first related information into a first encoder corresponding to the first modality to obtain a first feature, input the second related information into a second encoder corresponding to the second modality to obtain a second feature, and input the first feature and the second feature into a cross-encoder to obtain a multi-modality feature.

According to still another aspect of embodiments of this specification, a computer-readable storage medium is provided. The computer-readable storage medium stores a computer program. When the computer program is executed in a computer, the computer is enabled to perform any one of the above-mentioned methods.

According to yet another aspect of embodiments of this specification, a computing device is provided, and includes a storage and a processor. The storage stores executable code. When the processor executes the executable code, any one of the above-mentioned methods is implemented.

It should be understood that descriptions such as “first” and “second” in this specification are merely intended to distinguish between similar concepts for ease of description, and do not impose a limitation.

Although one or more embodiments of this specification provide the method operation steps as described in the embodiments or flowcharts, a conventional or uncreative means can include more or less operation steps. The step sequence listed in the embodiments is only one of a plurality of step execution sequences, and does not represent a unique execution sequence. When an apparatus or a terminal product actually performs the method, the apparatus or the terminal product can perform the method in the method sequence shown in the embodiments or the accompanying drawings or perform the steps in parallel (e.g., in a parallel-processor or multi-thread processing environment, or even in a distributed data processing environment). The term “include”, “comprise”, or any other variant thereof is intended to cover non-exclusive inclusion, so that a process, method, product, or device that includes a series of elements includes not only those elements but also other elements that are not expressly listed, or includes elements inherent to such a process, method, product, or device. Without more constraints, it is not excluded that the process, method, product, or device including the described elements can also include additional identical or equivalent elements.

For ease of description, the above-mentioned apparatus is described separately by dividing functions into various modules. Certainly, when one or more of the embodiments in this specification are implemented, functions of the modules can be implemented in the same or more pieces of software and/or hardware, or modules that implement the same function can be implemented by a combination of a plurality of submodules or subunits, etc. The apparatus embodiment described above is merely an example. For example, division into the units is merely logical function division and can be other division in actual implementation. For example, a plurality of units or components can be combined or integrated into another system, or some features can be ignored or not performed. In addition, the displayed or discussed mutual couplings or direct couplings or communication connections can be implemented by using some interfaces. The indirect couplings or communication connections between the apparatuses or units can be implemented in electronic, mechanical, or other forms.

A person skilled in the art should be aware of that one or more embodiments of this specification can be provided as a method, system, or computer program product. Therefore, the one or more embodiments of this specification can use a form of hardware only embodiments, software only embodiments, or embodiments with a combination of software and hardware. In addition, the one or more embodiments of this specification can use a form of a computer program product that is implemented on one or more computer-usable storage media (including but not limited to a disk storage, a CD-ROM, an optical storage, etc.) that include computer-usable program code.

The one or more embodiments of this specification can be described in the general context of computer-executable instructions executed by a computer, for example, a program module. Generally, the program module includes a routine, a program, an object, a component, a data structure, etc. executing a specific task or implementing a specific abstract data type. The one or more embodiments of this specification can alternatively be practiced in distributed computing environments. In these distributed computing environments, tasks are executed by remote processing devices that are connected through a communication network. In the distributed computing environments, the program module can be located in both local and remote computer storage media including storage devices.

The embodiments of this specification are described in a progressive manner. For same or similar parts in the embodiments, mutual references can be made to the embodiments. Each embodiment focuses on a difference from other embodiments. Particularly, the system embodiments are similar to the method embodiments, and therefore are described briefly. For related parts, reference can be made to partial descriptions in the method embodiments. In the descriptions of this specification, reference to the descriptions of the terms “one embodiment”, “some embodiments”, “example”, “specific example”, or “some examples” means that specific features, structures, materials, or characteristics described in the embodiments or examples are included in at least one embodiment or example of this specification. In this specification, example descriptions of the above-mentioned terms do not need to be specific to the same embodiment or example. In addition, the described specific features, structures, materials, or characteristics can be combined in a proper way in any one or more embodiments or examples. In addition, without mutual contradictoriness, a person skilled in the art can integrate or combine different embodiments or examples described in this specification and features of different embodiments or examples.

The above-mentioned descriptions are merely embodiments of one or more embodiments of this specification, and are not intended to limit the one or more embodiments of this specification. A person skilled in the art can make various changes and variations to the one or more embodiments of this specification. Any modification, equivalent replacement, or improvement made without departing from the spirit and principle of this specification shall fall within the scope of the claims.

1. A method for obtaining multi-modality features, comprising:
obtaining first information of a first modality, and obtaining first related information of the first modality and second related information of a second modality from a predetermined multi-modality retrieval database based on the first information; and
inputting the first information and the first related information into a first encoder corresponding to the first modality to obtain a first feature, inputting the second related information into a second encoder corresponding to the second modality to obtain a second feature, and inputting the first feature and the second feature into a cross-encoder to obtain a multi-modality feature.

2. The method according to claim 1, wherein the first modality and the second modality each are one of a text modality, an image modality, or a video modality, and the second modality is different from the first modality.

3. The method according to claim 1, further comprising:
obtaining second information of the second modality, and obtaining third related information of the second modality and fourth related information of the first modality from the multi-modality retrieval database based on the second information;
the inputting the first information and the first related information into a first encoder corresponding to the first modality to obtain a first feature comprises: inputting the first information, the first related information, and the fourth related information into the first encoder corresponding to the first modality to obtain the first feature; and
the inputting the second related information into a second encoder corresponding to the second modality to obtain a second feature comprises: inputting the second information, the second related information, and the fourth related information into the second encoder corresponding to the second modality to obtain the second feature.

4. The method according to claim 1, wherein a plurality of key-value pairs are pre-stored in the multi-modality retrieval database, a key in the key-value pair is used to store a feature of pre-obtained information of the first modality, and a value in the key-value pair is used to store related information of a same modality as the information of the first modality and related information of a different modality from the information of the first modality.

5. The method according to claim 4, wherein the key in the key-value pair has a first identifier that is used to identify a modality corresponding to the information stored in the key, and the value in the key-value pair has a second identifier that is used to identify a modality corresponding to the information stored in the value.

6. The method according to claim 4, wherein obtaining the first related information of the first modality and the second related information of the second modality from the predetermined multi-modality retrieval database based on the first information comprises:
extracting a first extracted feature from the first information through a pre-trained feature extractor; and
obtaining, from the predetermined multi-modality retrieval database, the first related information and the second related information that are comprised in values corresponding to a plurality of keys in a k-nearest neighbor of the first extracted feature.

7. The method according to claim 4, wherein the key in the key-value pair is further used to store a feature of pre-obtained information of the second modality, and the value in the key-value pair is used to store related information of a same modality as the information of the second modality and related information of a different modality from the information of the second modality.

8. The method according to claim 1, wherein the cross-encoder is based on a Transformer model.

9. The method according to claim 2, wherein the first modality is a text modality, and the first encoder corresponding to the first modality is based on one of a bag-of-words model, a sequence model, or an attention mechanism model.

10. The method according to claim 2, wherein the first modality is an image modality or a video modality, and the first encoder corresponding to the first modality is based on one of a convolutional neural network or a Transformer model.

11. The method according to claim 3, wherein the first modality is a text modality, the second modality is an image modality or a video modality, the first related information is context information of the first information, the second related information is an image or a video related to text content in the first information, the third related information is an image or a video of a same type as the second information, and the fourth related information is text related to image content in the second information.

12. An apparatus for obtaining multi-modality features, wherein the apparatus comprises:
a related information acquisition unit, configured to obtain first information of a first modality and obtain first related information of the first modality and second related information of a second modality from a predetermined multi-modality retrieval database based on the first information; and
a feature extraction unit, configured to input the first information and the first related information into a first encoder corresponding to the first modality to obtain a first feature, input the second related information into a second encoder corresponding to the second modality to obtain a second feature, and input the first feature and the second feature into a cross-encoder to obtain a multi-modality feature.

13. A computer-readable storage medium, wherein the computer-readable storage medium stores a computer program, and when the computer program is executed in a computer, the computer is enabled to perform the method according to any one of claims 1 to 11.

14. A computing device, comprising a memory and a processor, wherein the memory stores executable code, and when executing the executable code, the processor implements the method according to any one of claims 1 to 11.
